(19) United States
(12) Patent Application Publication
(10) Pub. No.: US 2008/0308474 A1
(43) Pub. Date: Dec. 18, 2008

(54) Diesel Fuel Filter

(75) Inventor: Giorgi Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., MANTOVA (IT)

(21) Appl. No.: 11/910,464

(22) PCT Filed: Feb. 23, 2006
(86) PCT No.: PCT/EP2006/001780

§ 371 Date: Jun. 24, 2008

(30) Foreign Application Priority Data
Apr. 6, 2005 (IT) RE2005A00036

(51) Int. Cl. F02M 37/22; B01D 36/00

(52) U.S. Cl. 210/132; 210/321.64

(57) ABSTRACT

A diesel fuel filter comprising an outer casing (2) which is provided at leas with an inlet conduit (40) for the diesel fuel to be filtered (A) and an outlet conduit (41) for the filtered diesel fuel (B), and houses internally at least one first filtering baffle (70) of high filtering efficiency which separates the interior of said casing (2) into two separate chambers, of which a first chamber (8) communicates with the outlet conduit (41) and a second chamber (9) communicates with the inlet conduit (40); the filter (1) also comprises a third chamber (10), which is separated from said first chamber (8) by at least one second filtering baffle (71) permeable to thickened paraffins, and is separated from said second chamber (9) by means (78) arranged to connect said second chamber (9) to said third chamber (10) when the temperature of the diesel fuel to be filtered (A) falls below a value responsible for the formation of thickened paraffins.

### TECHNICAL FIELD

The present invention relates to a diesel fuel filter, and more specifically to a diesel fuel filter to be connected to the feed circuit of a diesel engine.

### PRIOR ART

Diesel fuel for automotive use is known to normally contain impurities, because of which a diesel engine feed circuit must be provided with a suitable fuel filter positioned upstream of the injection device to retain said impurities before the diesel fuel is fed into the engine.

Modern diesel fuel filters generally comprise an outer casing, consisting of a cup-shaped body and a removable closure cover provided with an inlet conduit for the diesel fuel to be filtered and an outlet conduit for the filtered diesel fuel.

The inlet conduit is connected to the low pressure pump of the engine feed circuit, the outlet conduit being connected to the injection device.

The outer casing internally contains a filter cartridge, normally comprising a filtering baffle of toroidal form, which divides the interior of the outer casing into two separate chambers, of which one chamber communicates with the outlet conduit and one chamber communicates with the inlet conduit.

The chamber communicating with the inlet conduit is normally provided by the inner region of the filtering baffle, while the chamber communicating with the outlet conduit lies between the filtering baffle and the cup-shaped body.

To ensure optimum filtration of the diesel fuel during engine operation, the filtering baffle is generally a high efficiency filtering baffle, i.e. able to retain small-dimension impurities, and of long life, i.e. able to accumulate large quantities of such impurities before clogging and requiring replacement. In addition to such impurities, diesel fuel also generally contains paraffins, which, below a determined temperature of the order of −5° C., known as the paraffin precipitation temperature, tend to thicken and to separate from the diesel fuel, until they solidify completely at lower temperatures, of the order of −20/25° C.

High efficiency filtering baffles are generally impermeable to thickened paraffins; consequently, if the engine remains inactive for a certain time at a temperature less than the paraffin precipitation temperature, said thickened paraffins clog the filtering baffle and prevent passage of diesel fuel, at the same time making it impossible to restart the engine.

### DISCLOSURE OF THE INVENTION

The object of the present invention is to overcome the aforesaid drawback of the known art, by providing a diesel fuel filter which, in low temperature start situations, can ensure a minimum diesel fuel flow to the engine and simultaneously a sufficient level of filtration of impurities from the diesel fuel.

This object is attained by a diesel fuel filter comprising an outer casing which is provided at least with an inlet conduit for the diesel fuel to be filtered and an outlet conduit for the filtered diesel fuel, and houses internally at least one first filtering baffle of high filtration efficiency which separates the interior of said casing into two separate chambers, of which a first chamber communicates with the outlet conduit and a second chamber communicates with the inlet conduit.

According to the invention, the filter comprises a third chamber, which is separated from said first chamber by at least one second filtering baffle permeable to thickened paraffins, and is separated from said second chamber by means which connect said second chamber to said third chamber when the temperature of the diesel fuel to be filtered falls below a value responsible for the formation of thickened paraffins.

By virtue of this solution, during normal engine operation the diesel fuel passes exclusively through the high efficiency filtering baffle of the second chamber, being subjected to optimum filtration; however in low temperature start situations the diesel fuel passes through the filtering baffle of the third chamber, which being permeable to thickened paraffins allows a minimum diesel fuel flow to the engine to enable starting, without the diesel fuel filtration being insufficient.

Preferably, the filtering baffle of high filtering efficiency is a baffle of synthetic material, for example nylon; whereas the filtering baffle permeable to thickened paraffins is of cellulose.

According to the invention, said means for connecting the second and third chamber together are controlled by the pressure generated by the diesel fuel to be filtered, contained in said second chamber.

According to a preferred embodiment of the invention, said means comprise a flexible membrane arranged to close a passage port between the second and third chamber, and flexing to open said passage port when the diesel fuel to be filtered, contained in the second chamber, exerts on it a pressure greater than a determined limiting value.

In this manner, the filter operates completely automatically by a very simple and economical system. In this respect, when the temperature of the diesel fuel to be filtered is less than the paraffin precipitation temperature, the thickened paraffins clog the high efficiency filtering baffle, hence the pressure in the second chamber increases to cause flexure of the membrane, so allowing the diesel fuel to pass into the third chamber. In contrast, when the temperature of the diesel fuel to be filtered is greater than the paraffin precipitation temperature, the diesel fuel passes through the high efficiency filtering baffle, so that the pressure in the second chamber is insufficient to flex the membrane, which therefore closes the third chamber.

According to the invention, said flexible membrane is made of a material which preserves high elasticity even when immersed in diesel fuel at low temperature, for example fluorosilicone.

### BRIEF DESCRIPTION OF THE DRAWINGS

Further characteristics and advantages of the invention will be apparent on reading the ensuing description provided by way of non-limiting example, with the aid of the figures of the accompanying drawings, in which:

FIG. 1 is a longitudinal axial section through a diesel fuel filter according to the invention, shown when the temperature of the diesel fuel to be filtered is higher than the paraffin precipitation temperature;

FIG. 1′ is an enlarged detail of FIG. 1;

FIG. 2 is the same as FIG. 1, shown when the temperature of the diesel fuel to be filtered is less than the paraffin precipitation temperature;

FIG. 2′ is a detail of FIG. 2;

FIG. 3 is a longitudinal section through a filter cartridge pertaining to the filter of FIG. 1;

FIG. 4 is a section on the line IV-IV indicated in FIG. 3;

FIG. 5 is a section on the line V-V indicated in FIG. 3.

### BEST MODE FOR CARRYING OUT THE INVENTION

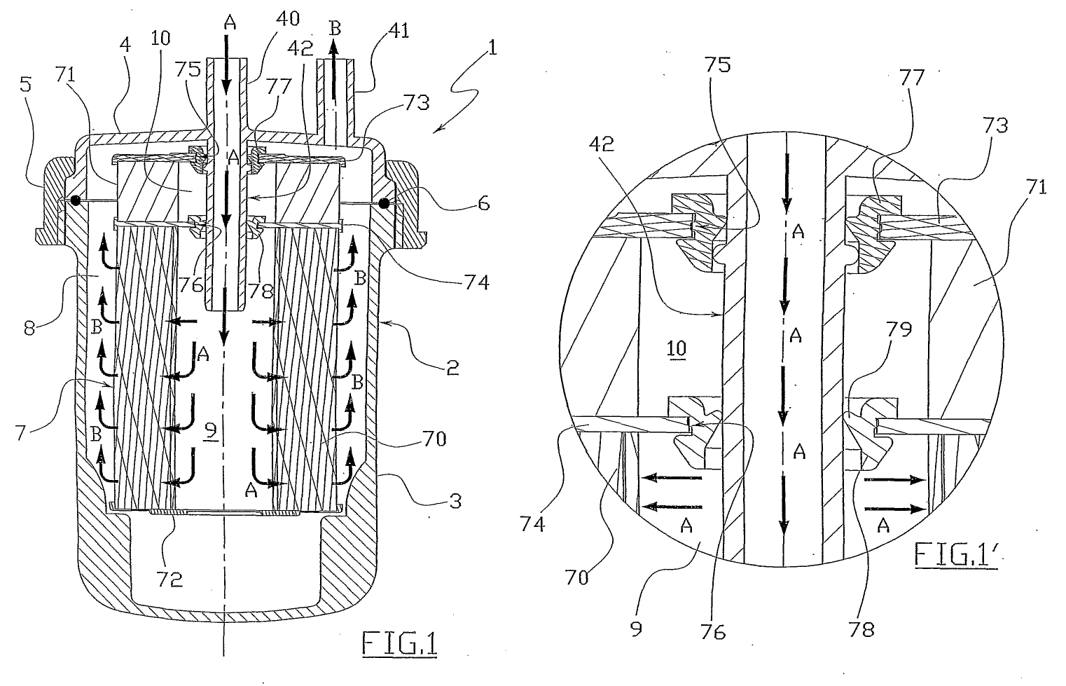

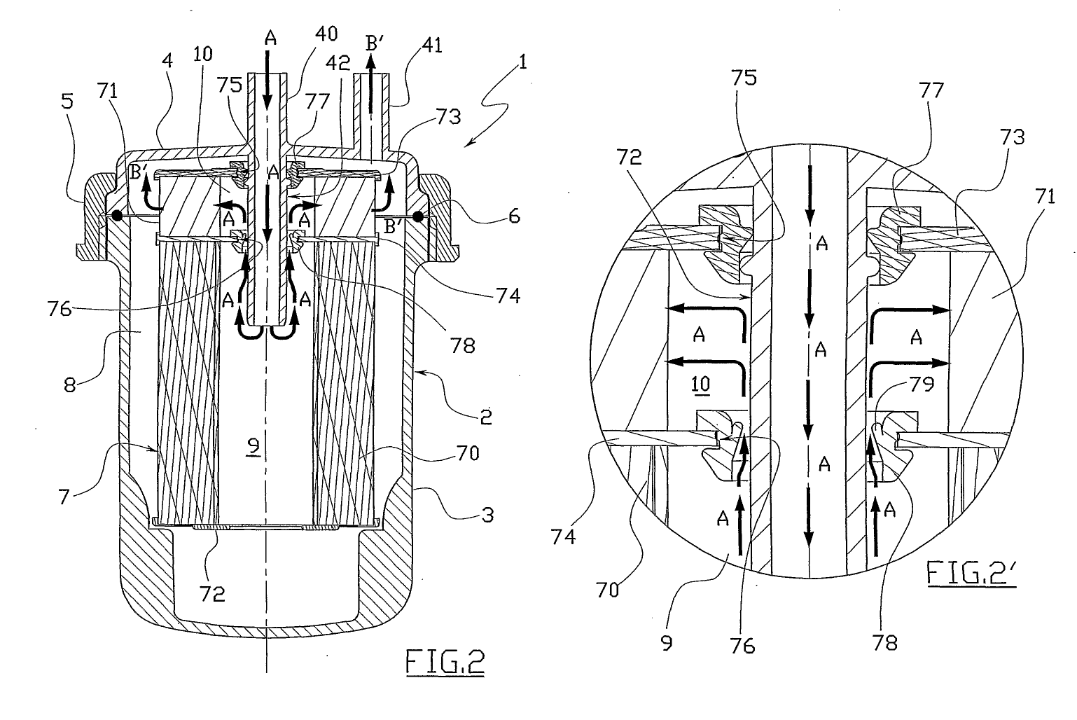

FIGS. 1 and 2 show a diesel fuel filter 1 to be connected to the feed circuit of a diesel engine between the low pressure pump, which draws diesel fuel from the tank, and the injection device.

The filter 1 comprises an outer casing 2, consisting of a cup-shaped hollow body 3 and a closure cover 4 which, via interposed seal means 6, is removably fixed to the body 3 by a ring nut 5.

The closure cover 4 is provided with a inlet conduit 40 for the diesel fuel to be filtered, connected to the low pressure pump, and with an outlet conduit 41 for the filtered diesel fuel, connected to the injection device. In particular, as shown in FIGS. 1 and 2, the inlet conduit 40 presents a portion 42 projecting into the space bounded by the casing 2, such as to open into a central region of said space, for the reasons which will be apparent hereinafter.

The outer casing 2 internally contains a filter cartridge 7 to be traversed by the diesel fuel to be filtered, and able to retain the impurities contained therein before the diesel fuel is fed into the engine.

As shown in FIG. 3, the filter cartridge 7 comprises two mutually superposed coaxial toroidal filtering baffles 70 and 71, the lower filtering baffle 70 being of high efficiency and long life and the upper filtering baffle 71 being of low filtration efficiency and short life and being permeable to those paraffins which thicken in the diesel fuel to be filtered below the paraffin precipitation temperature.

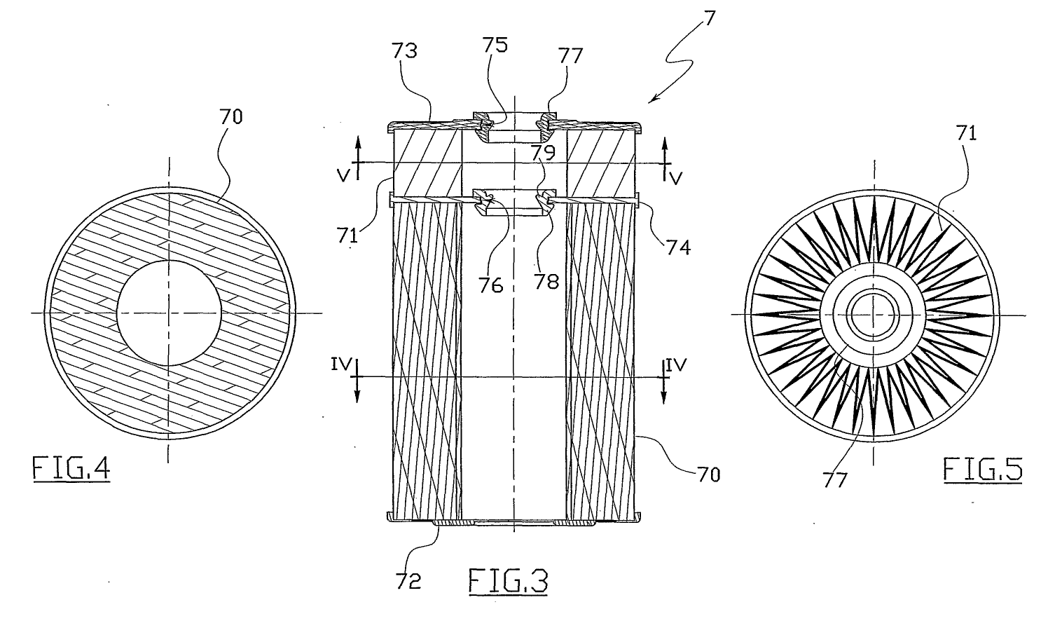

Specifically, the lower filtering baffle 70 is a thick-walled baffle of synthetic material, for example nylon (see FIG. 4), whereas the upper filtering baffle 71 is a thin-walled baffle of cellulose, pleated to star shape (see FIG. 5), such as to present a plurality of longitudinal pleats disposed substantially radially about a central axis, to advantageously provide a large passage surface within a relatively small space.

The free ends of the lower filtering baffle 70 and upper filtering baffle 71 are closed respectively by a lower disc 72 and an upper disc 73, which are fixed to them by adhesive or fusion.

Said lower baffle 70 and upper baffle 71 are separated by an intermediate disc 74, which is fixed by adhesive or fusion to the upper baffle 71 on one side and to the lower baffle 70 on the opposite side.

As shown in FIG. 3, the upper disc 73 and the intermediate disc 74 are each provided with a central hole 75 and 76 respectively, which are coaxial with the filtering baffles 70 and 71 so that they face each other in the inner region of these latter.

With each central hole 75 and 76 there is associated a seal ring, namely an upper 77 and an intermediate 78, the purpose of which will be apparent hereinafter.

As shown in FIGS. 1 and 2, said filter cartridge 7 is coupled to the projecting portion 42 of the inlet conduit 40 by inserting said projecting portion 42 through the central hole 75 of the upper disc 73 and through the central hole 76 of the intermediate disc 74, by way of the seal rings 77 and 78, so that it passes through the inner region of the upper filtering baffle 71 and opens into the inner region of the lower filtering baffle 70.

In this manner, the interior of the casing 2 is divided into three separate chambers, namely a first chamber 8 lying between the filter cartridge 7 and the cup-shaped body 3 and communicating with the outlet conduit 41 for the filtered diesel fuel, a second chamber 9 defined by the inner region of the lower filtering baffle 70 and communicating with the inlet conduit 40 for the diesel fuel to be filtered, and a third chamber 10 defined by the inner region of the upper filtering baffle 71 and closed upperly by the seal ring 77 and lowerly by the seal ring 78.

The purpose of the seal ring 77 is to ensure hermetic separation between the chamber 10 and the chamber 8 under any operating condition; consequently, as shown in FIGS. 1′ and 2′, it presents a particular geometry which prevents seepage of the diesel fuel, and is also made of a material providing an excellent seal against diesel fuel, for example NBR. Instead, the purpose of the intermediate seal 78 is to allow flow of the diesel fuel to be filtered from the chamber 9 to the chamber 10 when said diesel fuel contains thickened paraffins which do not enable it to pass through the lower filtering baffle 70.

For this reason, said seal ring 78 is made of a material which possesses high elasticity even when immersed in diesel fuel at low temperature, for example fluorosilicone, and is shaped to present an thin elongated lip 79 which is able to flex when the diesel fuel contained in the second chamber 9 exerts on it a pressure higher than a determined limiting value (see FIGS. 1′, 2′).

When in use, as shown in FIGS. 1 and 1′, when the diesel fuel temperature exceeds the paraffin precipitation temperature, the diesel fuel to be filtered, indicated by A in the figures, enters the interior of the chamber 9 through the inlet conduit 40, and passes directly into the chamber 8 by passing through the lower filtering baffle 70 of high efficiency. From there the filtered diesel fuel, indicated by B in the figures, leaves the chamber 8 through the outlet conduit 41 to feed the injection device.

In this situation, the resistance offered by the filtering baffle 70 to passage of the diesel fuel is insufficient to generate within the chamber 9 a pressure enabling the lip 79 of the seal ring 78 to flex; consequently the diesel fuel A to be filtered is unable to enter the third chamber 10.

In an engine start situation after a lengthy stay at a temperature less than the paraffin precipitation temperature, the paraffins which have thickened within the diesel fuel A to be filtered prevent passage of this latter through the lower baffle 70 of high efficiency (see FIG. 2).

For this reason, on starting the low pressure pump of the feed circuit, the diesel fuel to be filtered A, which enters from the inlet conduit 40, increases the pressure within the chamber 9, to cause the lip 79 of the intermediate ring 78 to flex.

In this manner, as shown in FIG. 2′, the diesel fuel A to be filtered flows into the chamber 10, where it results in a pressure increase enabling the diesel fuel to pass through the upper filtering baffle 71, which is permeable to thickened paraffins.

Consequently, the flow B′ of partially filtered diesel fuel passes into the chamber 8 and reaches the injection device through the outlet conduit 41 to enable the engine to start.

When the engine has started, a part of the diesel fuel B′ which reaches the injection device returns to the tank at a higher temperature; consequently as time passes, the temperature of the diesel fuel within the feed circuit reaches a value exceeding the paraffin precipitation temperature.

In this manner the thickened paraffins dissolve, the diesel fuel A to be filtered then being able to pass through the lower filtering baffle 70 of high efficiency. The pressure within the chamber 9 falls progressively to below the pressure required to flex the lip 79, which closes access to the third chamber 10 and restores normal operation of the filter 1.

1. A diesel fuel filter comprising an outer casing (2) which is provided at least with an inlet conduit (40) for the diesel fuel (A) to be filtered and an outlet conduit (41) for the filtered diesel fuel (B), and houses internally at least one first filtering baffle (70) of high filtration efficiency which separates the interior of said casing (2) into two separate chambers, of which a first chamber (8) communicates with the outlet conduit (41) and a second chamber (9) communicates with the inlet conduit (40), characterised by comprising a third chamber (10), which is separated from said first chamber (8) by at least one second filtering baffle (71) permeable to thickened paraffins, and is separated from said second chamber (9) by means (78) arranged to connect said second chamber (9) to said third chamber (10) when the temperature of the diesel fuel (A) to be filtered falls below a value responsible for the formation of thickened paraffins.

2. A filter as claimed in claim 1, characterised in that the first filtering baffle (70) of high filtration efficiency is of synthetic material.

3. A filter as claimed in claim 2, characterised in that said synthetic material is nylon.

4. A filter as claimed in claim 1, characterised in that the second filtering baffle (71) permeable to thickened paraffins is of cellulose.

5. A filter as claimed in claim 1, characterised in that said means (78) for connecting the second chamber (9) and third chamber (10) together are controlled by the pressure generated by the diesel fuel (A) to be filtered, inside said second chamber (9).

6. A filter as claimed in claim 5, characterised in that said means for connecting the second chamber (9) and third chamber (10) together comprise a flexible membrane (78) which closes a passage port (76) between the second and third chamber (9, 10), and is able to flex, to open said passage port (76), when the diesel fuel (A) to be filtered, contained in the second chamber (9), exerts thereon a pressure greater than a predetermined limiting value.

7. A filter as claimed in claim 6, characterised in that the flexible membrane (78) is made of a material which preserves high elasticity when immersed in diesel fuel at low temperature.

8. A filter as claimed in claim 7, characterised in that said membrane (78) is made of fluorosilicone.

9. A filter as claimed in claim 6, characterised in that the first filtering baffle (70) and the second filtering baffle (71) are both of toroidal form so that their inner region defines said second and third chamber (9, 10) respectively, are mutually superposed, and are separated by an intermediate disc (74) provided with a central hole (76), with which said flexible membrane (78) is associated.

10. A filter as claimed in claim 9, characterised in that the second filtering baffle (71) is a thin walled baffle pleated in accordance with a star geometry.

11. A filter as claimed in claim 9, characterised in that the inlet conduit (40) for the diesel fuel (A) to be filtered is provided with a projecting portion (42) which extends into the interior of the outer casing (2) by passing through the third chamber (10), passing through the central hole (76) in the intermediate disc (74) and opening into the second chamber (9); the membrane being a seal ring (78) interposed between the central hole (76) and the projecting portion (42) of the inlet conduit (40) and comprising a filter lip (79) able to flex, to allow passage of the diesel fuel (A) to be filtered, when the pressure exerted by this latter exceeds said threshold value.

12. A filter as claimed in claim 11, characterised in that the free end of the second filtering baffle (71) is closed by an upper disc (73) provided with a central hole (75) through which the projecting portion (42) of the inlet conduit (40) passes by way of an interposed seal ring (77).

13. A filter as claimed in claim 12, characterised in that said seal ring (77) interposed between the central hole (75) of the upper disc (73) and the projecting portion (42) of the inlet conduit (40) is made of a material which provides an excellent seal against diesel fuel.
